(19) United States
(12) Patent Application Publication
(10) Pub. No.: US 2008/0069174 A1
(43) Pub. Date: Mar. 20, 2008

(54) Electrode Support Arm

(75) Inventors: Sven Beermann, Mulheim (DE); Udo Hildebrandt, Essen (DE)

Correspondence Address: BOYLE FREDRICKSON S.C., 840 North Plankinton Avenue, MILWAUKEE, WI, 53203, US

(73) Assignee: Homa Gesellschaft F. Hochstrom-Magnetschalter V. Vollenbroich GmbH & Co. KG, Oberhausen (DE)

(21) Appl. No.: 11/857,066

(22) Filed: Sep. 18, 2007

(30) Foreign Application Priority Data
Sep. 18, 2006 (EP) 06019488.3

(51) Int. Cl. H05B 7/10

(52) U.S. Cl. 373/94

(57) ABSTRACT

The present invention relates to an electrode arm for arc furnaces comprising an electrode receiving means provided at the front end thereof, said arm having a profile comprising steel plates cladded with electrically highly conductive plates on the outside of the profile. An electrically highly conductive electrode support arm, which has its own weight reduced and can be produced at reduced manufacturing costs, is created in that the cladded steel plates are provided spaced apart from one another in a circumferential direction of the profile and are connected to each other. An electrically conductive outer wall is formed by inclusion of the electrically highly conductive plates.

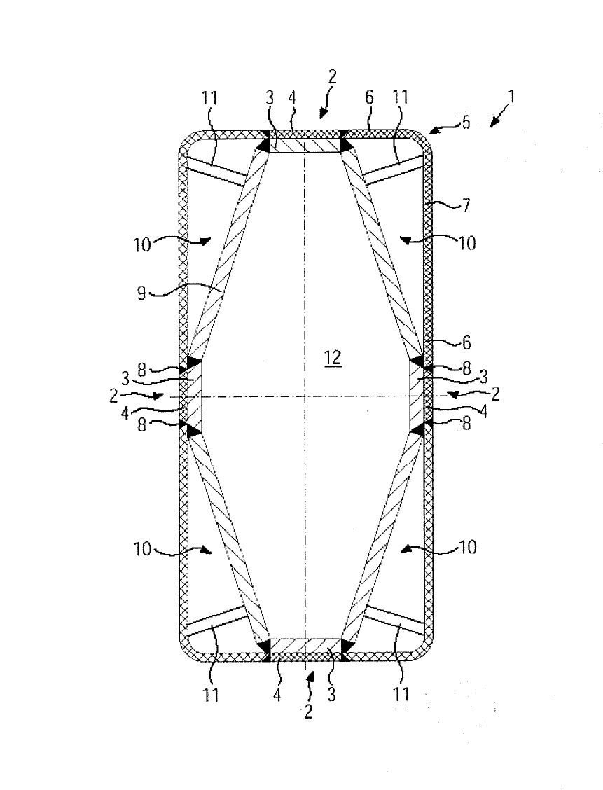

### BACKGROUND OF THE INVENTION

1. Field of the Invention

The present invention relates to an electrode arm for arc furnaces with an electrode receiving means provided at the front end thereof, said arm having a profile including steel plates cladded with electrically highly conductive plates on the outside of the profile.

2. Description of the Related Art

Electrode support arms for arc furnaces used for steel production serve to hold electrodes, which are normally given a round cross-section and are made from graphite. Said electrodes are held on an electrode receiving means formed by the electrode support arm. This means is normally formed by a clamp that grips the electrode on its circumference, thereby holding the same.

As a rule, an electrode support arm is vertically movable in the longitudinal direction of the electrodes so as to control the penetration depth of the electrode into the arc furnace, thereby influencing the formation of the arc. Particular attention is here paid to a use of the electrodes that is as gentle as possible. However, it may of course happen that for the fusion of scrap the electrodes are impinging at a relatively high speed on the scrap heap located inside the arc furnace. An electrode arm is thus exposed to correspondingly high mechanical loads and must show adequate stiffness and strength, but should be as lightweight as possible to permit a rapid change in penetration depth.

Moreover, very high currents are used at very high voltages in arc furnaces. This entails the problem that electrical arcing may occur between the current-carrying electrode arm and its environment. Moreover, the electrode support arm is cooled because of the thermal load that is also due to power conduction. Apart from the support arm being heated by the flowing current, care must be taken that the electrode support arm is not impermissibly heated because of the thermal conditions prevailing in the arc furnace. As a consequence, cooling ducts extending in the longitudinal direction of the support arm normally extend through electrode support arms. With a corresponding cooling duct, cooling liquid, normally water, is transported from the rear electrode support arm to the front end. At said place the cooling liquid usually cools the contact surfaces for the electrode at the support arm side, said contact surfaces being usually formed by a contact jaw designed in accordance with the contour of the electrode. A clamp clip that is displaceable relative to the support arm is additionally cooled and presses at the side opposite the contact jaw against the electrode, thereby fixing the electrode to the electrode support arm. On account of the relative movability of the clamp clip, the latter is usually supplied via flexible lines with cooling liquid, the lines either starting from the support arm and communicating with the flow ducts formed thereat, or communicating with the source for the cooling liquid, thereby obviating the flow ducts in the electrode support arm.

Due to the high currents the additional problem arises that, on account of the profiled shape of the hollow profile, voltage peaks should be avoided and the electrode support arm should show an electrical resistance as low as possible with respect to the current to be conducted through the support arm.

The complex mechanical, thermal and electrical demands made on the support arm have led to different solution proposals shown in the prior art.

For instance, it has been suggested in U.S. Pat. No. 2,494,775 that the support arm should be made of copper on the whole and configured in a current-conducting manner. The electrode support arm is here made hollow and is provided at the front end with a flange plate forming the contact jaw. Such an electrode support arm does not satisfy the mechanical demands to be made because copper does not show the necessary strength—at least at the weight of a support arm to be tolerated, which amounts to about 4 to 10 tons. Moreover, there is the risk because of the relatively low melting point that copper softens and/or starts to melt at the front end of the electrode support arm when used in the electrode arc furnace.

In an alternative solution suggested in FR-A-1 336 823, the electrode support arm is entirely made from aluminum. Because of the small current load the support arm itself, which is formed as a hollow profile, is not cooled. Tubes which are connected from the outside to the clamp clip and are guided in the further extension inside the hollow profile are provided for the clamp clip of the electrode receiving means.

A support arm of reduced weight in comparison therewith is suggested in EP 0 594 272. This support arm has a hollow profile formed by extruded aluminum. The cooling ducts are here formed inside the aluminum material. The cavity enclosed by the hollow profile is not filled with water and is thus of a reduced weight. Cooling of the profile forming the electrode support arm is solely performed via the cooling ducts recessed in the aluminum.

This solution is disadvantageous with respect to the costs entailed by the production process. On the other hand, an electrode support arm made from aluminum might not withstand the mechanical loads and get deformed.

This flaw is remedied with the help of another design principle, which is known from EP-A-0 184 140 and in which the support arm is made from a plurality of flat steel plates that are welded to one another and are cladded on their outside with copper. The intimate connection between steel and copper by way of cladding is needed for preventing corrosion, which must otherwise be feared because of the high currents, the presence of cooling water in the hollow profile and the thermal loads caused by the heating and cooling of materials showing a different thermal expansion in the support arm at the phase boundary between the steel plate and the copper plate. Cladding, however, is very troublesome and cost-intensive. Furthermore, precise work is required on the welds of the cladded steel sheets that are normally found in the corners of the profile. For instance, the steel sheet cladded with copper must first be cut off obliquely for welding purposes. Thereupon, the steel plates are welded. The resulting outside of the weld seam must be smoothed. Thereafter, a copper intermediate is provided in the area of the corner of the hollow profile, the intermediate partly covering the steel seam. For continuing the copper cladding of the steel plate a copper weld seam is introduced between the copper intermediate and the cladding. Moreover, a copper weld seam of adequate thickness must be formed at the butt joint of the cladded steel plates that are abutting on each other in the case of a rectangular hollow profile at an angle of 90° C. With an inappropriate design of said weld seams, considerable voltage peaks may arise at the corners of the hollow profiles.

The configuration of copper-cladded steel plates for forming the hollow profile is thus an expensive alternative to the above-mentioned design principles, the alternative being exacting under quality assurance aspects.

Starting from the prior art according to EP-A-0 184 140, the present invention is based on the problem to provide an electrode support arm satisfying the demands in a better way, the hollow profile of the arm showing adequate strength and substantially avoiding voltage peaks.

### OBJECT OF THE INVENTION

For the solution of this problem the present invention provides an electrode support arm comprising the features of claim 1. The electrode support arm according to the invention differs from the generic prior art in that the cladded steel plates are provided spaced apart from one another in the circumferential direction of the profile and are connected to each other, and that the profile comprises an electrically conductive outer wall formed by inclusion of the electrically highly conductive plates cladded onto the steel plates.

In the proposal according to the invention the relatively firm cladded steel plates are just provided in sections in the circumferential direction of the profile. These steel plates cladded with highly conductive plates serve the structural integrity of the electrode arm and are connected to one another, e.g. by way of struts, or the like, extending inside the profile. Thus the cladded steel plates form the support skeleton of the support arm. Connection segments which are connected, preferably welded or soldered, to the plates of highly electroconductive material cladded to the steel plates are provided between circumferentially neighboring cladded steel plates. Only together with the plates cladded onto the steel plates, said connection segments will form a substantially circumferentially closed outer wall of the profile taking over the electrical conduction of the current leading to the electrode. Thus the outer wall consists in circumferentially alternating fashion of wall segments formed by the conductive plates cladded onto the steel plates, and partly of connection segments provided between individual steel plates and connected in electrically highly conductive fashion to the electrically highly conductive plates cladded onto the steel plates.

The profile according to the invention may be a hollow profile in a manner known per se, said hollow profile having a cooling liquid flowing therethrough on the whole and being possibly subdivided—by a partition inserted into the profile—into cooling ducts for supplying and discharging the cooling liquid.

Various cooling means are possible, the means being assigned to the connection segments and/or the steel plates. For further weight reduction the connection segments preferably comprise cooling ducts on their inside. Said cooling ducts are assigned to the connection segments, i.e. they do not require the whole inner region of the cavity. The cooling ducts may e.g. be soldered or welded onto the inside of the connection segments or recessed on the inside in the connection segments. Such a configuration is e.g. recommended whenever the electrically highly conductive material is aluminum and the connection segments, or the semifinished products forming the connection segments, are produced by extrusion. In this preferred design the steel plates have assigned thereto separate cooling means, e.g. in the form of cooling ducts provided on the inside of the steel plates, the tubes of which are fastened to the inner surface of the steel plates or the outer wall of which is formed by the inner wall of the steel plates. These cooling ducts assigned to the steel plates do also not occupy the whole interior of the profile formed as a hollow profile.

For further weight reduction and for an efficient cooling it is suggested according to a preferred development of the present invention that a cooling means should only be assigned to the connection segments and that the cladded steel plates should be dimensioned in wall extension direction such that adequate cooling of the cladded steel plates is performed by heat conduction into the cooled connection segments. This development is prompted by the idea that the connection segments are formed from an electrically highly conductive material, but are also formed from a thermally highly conductive material. The cooling means assigned to the connection segments ensure an efficient heat discharge at said place. This preferred development omits a cooling means for the cladded steel plates. Instead of this, the steel plates are dimensioned in the direction of the wall extension such that adequate cooling of the externally arranged cladded steel plates is accomplished by heat conduction specifically in the plane of the plates of electrically highly conductive material cladded onto the steel plates.

Connection segments that form the outer wall of the profile are meant to be such structural members that are formed from an electrically highly conductive material and connected to the cladded steel plates, preferably abut at the front side on the plates of electrically highly conductive material cladded onto the steel plates and form with said plates a substantially step-free wall on the outside. The connection segments and the weld seams connecting the cladded steel plates may however be visible on the outer wall of the profile.

According to a preferred development the connection segments and the plates cladded thereonto are made from the same material, preferably provided with the same wall thickness. Especially aluminum and copper are suited as materials for forming the cladded plates and the connection segments.

According to a further preferred development of the present invention the connection segments comprise various sections, namely two sections normally extending in straight fashion and a radius section provided thereinbetween. The first-mentioned sections are connected to the neighboring steel plates of the associated connection segments and continue the plates cladded onto said steel plates and made of a highly electroconductive material. The above-mentioned, preferably straight sections of the connection segments are not necessarily provided offset relative to one another at an angle of 90°. Neighboring steel plates can also be arranged offset relative to one another at an angle different from 90°, for instance, to form a polygonal section. For preventing voltage peaks the radius of the radius section should be relatively large, e.g. have a ratio of inner radius of curvature to wall thickness of the connection segment of 1.25 and more. The ratio should preferably be above 2.25 and particularly preferably above 2.45.

To avoid defects that might lead to voltage peaks inside the profile, it is suggested according to a further preferred design of the present invention that a connection element that is integrally formed in circumferential direction should be provided between two circumferentially successive steel plates. Insofar as within the scope of the description of the present invention and the preferred designs thereof reference is made to the special design of the profile, this is basically done with respect to the circumferential direction. Of course, different profile pieces may be provided one after the other and connected to one another in the axial direction of the profile, i.e. in the longitudinal direction of the electrode support arm. The segments forming the individual profile pieces may here also overlap in axial direction.

Various designs are possible for stiffening the profile. The stiffening is accomplished by connecting the steel plates to one another. For instance, the steel plates may be connected according to a preferred development of the present invention with strutted sheets extending inside the profile and forming flow ducts for the coolant in the profile. Hence, the strutted sheets assume two functions, namely on the one hand stiffening the steel plates relative to one another and on the other hand assuming the function of a partition for forming flow ducts for cooling the support arm.

A particularly efficient cooling together with a relatively stiff configuration of the electrode support arm and a low weight of said arm is accomplished according to a preferred design in the case of which steel plates succeeding one another in circumferential direction are connected by strut segments spaced apart from the associated connection segments, which form a flow duct between themselves and the inner surface of the outer wall. Hence, the flow duct is formed on the inside of the profile by the strut segment and on the outside by the inner surface of the connection segment. The coolant is just passed into the remaining free space between the connection segment and the associated strut segment. The strut segments may have any desired geometric configuration and, particularly with respect to a relatively small flow cross-section of the cooling ducts, they may be matched to the shape of the connection segments.

However, it is preferred because of the demands made on strength and for the sake of an inexpensive production that neighboring end faces of circumferentially successive steel plates are connected in straight fashion, e.g. by flat strut segments of steel which are made identical in terms of material to the cladded steel plate and are welded to said steel plate.

The connection element assigned to this strut segment is preferably outwardly curved relative to the corresponding strut segment. Hence, a profile can be configured as a hollow profile whose outer surface is partly formed by the cladded straight steel plates and partly by the curved connection segments and in which further steel plates are extending as strut segments interconnecting neighboring cladded steel plates. Hence, this yields a polygonal support structure of the support arm that is formed by interconnected steel plates and the electrically conductive outer wall of which rests partly directly as cladded plates on the steel plates and partly extends at a distance from the strut segments and is here cooled at any rate by coolant which is passed through the support arm between the strut segment and the associated connection segment.

A profile is regarded as particularly expedient that is formed as a hollow rectangular profile and comprises four connection segments that extend between cladded steel sheets orthogonally oriented relative to one another and form the corners of the rectangular profile as generously curved sheets. The strut segments stiffening said profile form an octagon together with the steel plates including the cladded plates of electrically highly conductive material.

According to a preferred development of the present invention one or more supports may be provided between the strut segments and the associated connection segment for making the connection segment less prone to deformation by external impacts, or the like.

### BRIEF DESCRIPTION OF THE DRAWING

Further details and advantages of the present invention become apparent from the following description of an embodiment taken in conjunction with the drawing, which is a cross-sectional view through an embodiment of a profile for an electrode support arm.

### DETAILED DESCRIPTION OF THE PREFERRED EMBODIMENT

In the drawing the hollow profile is marked with reference numeral 1. The profile 1 has four identically shaped cladded steel plates 2 including a steel plate 3 and a copper plate 4 cladded thereonto. Said cladded steel plates 2 have arranged thereinbetween respective connection segments 5 made of copper, each comprising two straight sections 4 and a curved section 7 arranged between said sections 6 and forming a 90°-corner in the instant case. The connection segments 5 are each welded at the front side to the copper plates 4. The thickness of the connection segments 5 corresponds substantially to the thickness of the copper plates 4. The connection segments 5 with the weld seams connecting the cladded steel plates 2 are marked with reference numeral 8.

The steel plates 3 in circumferential direction of neighboring cladded plates 2 are interconnected via strut segments 9 that are formed in the instant case by flat steel plates in the material of the steel plates 3. Said strut segments 9 are welded at the front side to the steel plates 3, thereby forming with said plates the stable polygonal support structure of the hollow profile 1. Moreover, the strut segments 9 form the inner wall of a cooling duct 10 for each individual connection segment 5. Each of said cooling ducts 10 has provided therein a support 11 which extends between the corresponding strut segments 9 and the associated connection segment 5 and makes the respective connection segment 5 less prone to deformation caused by external impacts.

The predominant part of the interior of the hollow profile 1, i.e. the chamber 12 enclosed by the steel plates 3 and the strut segments 9, is not filled with water, but just with air. Of course, supply lines or control lines and sensor lines, respectively, may be positioned inside said chamber 12, for instance for a drive which is provided at the front end of the electrode support arm and clamps the clamp clip.

1. An electrode support arm for arc furnaces that has an electrode receiver provided at the front end thereof, said arm having a profile comprising steel plates cladded with electrically highly conductive plates on the outside of said profile, wherein the cladded steel plates are provided spaced apart from one another in a circumferential direction of the profile and are connected to each other, and wherein the profile has an electrically conductive outer wall formed by inclusion of the electrically highly conductive plates cladded onto the steel plates.

2. The electrode support arm according to claim 1, wherein the outer wall comprises connection segments of an electrically highly conductive material connected to the electrically highly conductive plates of the steel plate.

3. The electrode support arm according to claim 1, wherein a cooling device is assigned to the cladded steel plates.

4. The electrode support arm according to claim 2, wherein a cooling device is assigned to the connection segments.

5. The electrode support arm according to claim 2, wherein the connection segments are provided on their inside with a cooling duct.

6. The electrode support arm according to claim 2, wherein a cooling device is assigned to only the connection segments and the cladded steel plates are dimensioned in a wall extension direction such that the cladded steel plates are adequately cooled by heat conduction into the cooled connection segments.

7. The electrode support arm according to claim 2, wherein the connection segments abut at a front side thereof onto the electrically highly conductive plates.

8. The electrode support arm according to claim 2, wherein the connection segments and the electrically highly conductive plates are made from the same material and have the same wall thickness.

9. The electrode arm according to claim 2, wherein the connection segments comprise sections continuing the electrically highly conductive plates and at least one radius section arranged thereinbetween.

10. The electrode support arm according to claim, 9 wherein the radius section has a radius of curvature corresponding at least to 1.25 of the wall thickness of the connection segments.

11. The electrode support arm according to claim 2, wherein a connection segment is provided between two circumferentially successive cladded steel plates and is integrally formed with the two successive cladded steel plates in a circumferential direction.

12. The electrode support arm according to claim 4, wherein a connection segment is provided between two circumferentially successive cladded steel plates and is integrally formed with the two successive cladded steel plates in a circumferential direction.

13. The electrode support arm according to claim 11, wherein the steel plates are connected to one another by strutted sheets which are welded thereonto, and wherein the steel plates extend inside the profile and form flow ducts in the profile.

14. The electrode support arm according to claim 11, wherein circumferentially successive steel plates are connected to one another by strut segments that are provided at a distance from the associated connection segments and that form a flow duct between themselves and the inner surface of the outer wall.

15. The electrode support arm according to claim 11, wherein neighboring front faces of circumferentially successive steel plates are connected by a straight strut segment.

16. The electrode support arm according to claim 15, wherein each connection segment is outwardly curved relative to the associated strut segment.

17. The electrode support arm according to claim 1, wherein the profile is formed as a hollow rectangular profile and comprises four connection segments which each extend between neighboring cladded steel sheets that are oriented orthogonally relative to one another and that form corners of the rectangular profile as generously curved sheets.

18. The electrode support arm according to claim 17, wherein at least, one support extends between the connection segment and the strut segment.

19. The electrode support arm according to claim 11, wherein the profile is formed as a hollow rectangular profile and comprises four connection segments which each extend between neighboring cladded steel sheets that are oriented orthogonally relative to one another and that form corners of the rectangular profile as generously curved sheets.

20. The electrode support arm according to claim 19, wherein at least one support extends between the connection segment and the strut segment.
